(19) United States
(12) Patent Application Publication
(10) Pub. No.: US 2013/0162383 A1
(43) Pub. Date: Jun. 27, 2013

(54) INDUCTION ELEMENT AND INDUCTION DEVICE

(71) Applicant: KABUSHIKI KAISHA TOYOTA JIDOSHOKKI, Kariya-shi (JP)

(72) Inventor: Sergey MOISEEV, Aichi-ken (JP)

(73) Assignee: KABUSHIKI KAISHA TOYOTA JIDOSHOKKI, Kariya-shi (JP)

(21) Appl. No.: 13/717,748

(22) Filed: Dec. 18, 2012

(30) Foreign Application Priority Data
Dec. 22, 2011 (JP) 2011-282071

(51) Int. Cl. H01F 5/00; H01F 27/02

(52) U.S. Cl. CPC H01F 5/003; H01F 27/02
USPC 336/92; 336/200

(57) ABSTRACT

The induction element includes an insulating substrate, a coil, a core and an insulating projection or a groove. The coil is formed on at least a surface of the insulating substrate. The core has a part around which the coil is wound. The insulating projection or the groove is formed on or in the surface of the insulating substrate between the coil and the core.

### BACKGROUND OF THE INVENTION

The present invention relates to an induction element and an induction device.

In the transformer disclosed by Japanese Unexamined Utility Model Application Publication No. 6-9111, a coil provided by a conductive pattern is formed on the surface of a printed-circuit board and a sub-board is located over the coil. A coil provided by a conductive pattern is formed on the surface of the sub-board. An upper core and a lower core are mounted to the printed-circuit board so as to sandwich the printed-circuit board and the sub-board.

The creepage distance needs to be ensured on the surface of an insulating substrate on which the coil is formed, which causes the size of the substrate to be increased. The present invention is directed to providing an induction element and an induction device that ensure creepage distance without increasing the size of the insulating substrate.

### SUMMARY OF THE INVENTION

In accordance with a first aspect of the present invention, the induction element includes an insulating substrate, a coil, a core and an insulating projection or a groove. The coil is formed on at least a surface of the insulating substrate. The core has a part around which the coil is wound. The insulating projection or the groove is formed on or in the surface of the insulating substrate between the coil and the core.

In accordance with a second aspect of the present invention, the induction device includes a case, an insulating substrate, a coil, a core, a pressing member and an insulating projection or a groove. The insulating substrate is fixed in the case. The coil is formed on at least a surface of the insulating substrate. The core is located in the case and has a part around which the coil is wound. The pressing member is provided for fixing the core to the case. The insulating projection or the groove is formed on or in the surface of the insulating substrate between the coil and the case.

Other aspects and advantages of the invention will become apparent from the following description, taken in conjunction with the accompanying drawings, illustrating by way of example the principles of the invention.

### BRIEF DESCRIPTION OF THE DRAWINGS

The invention together with objects and advantages thereof, may best be understood by reference to the following description of the presently preferred embodiments together with the accompanying drawings in which:

FIG. 1A is a plan view of an induction device according to an embodiment of the present invention;

FIG. 1B is a sectional view of the induction device as taken along the line A-A in FIG. 1A;

FIG. 2A is a sectional view of the induction device as taken along the line B-B in FIG. 1A;

FIG. 2B is a sectional view of the induction device as taken along the line C-C in FIG. 1A;

FIG. 3A is a plan view of a heavy copper board of the induction device of FIG. 1A;

FIG. 3B is a sectional view of the heavy copper board as taken along the line A-A in FIG. 3A;

FIG. 3C is a bottom view of the heavy copper board of FIG. 3A;

FIG. 4 is a fragmentary sectional view of the induction device illustrating creepage distance;

FIG. 5A is a fragmentary sectional view of an insulating substrate of the induction device of Fig. IA;

FIGS. 5B through 5F are fragmentary sectional views of modifications over the insulating substrate of FIG. 5A; and

FIGS. 6A through 6E are fragmentary sectional views of modifications of the induction device.

### DETAILED DESCRIPTION OF THE EMBODIMENTS

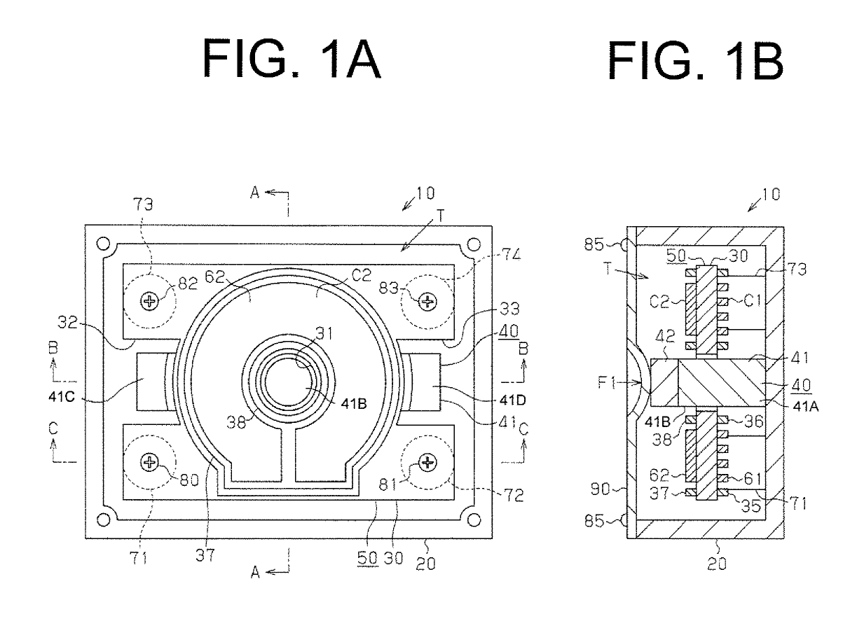

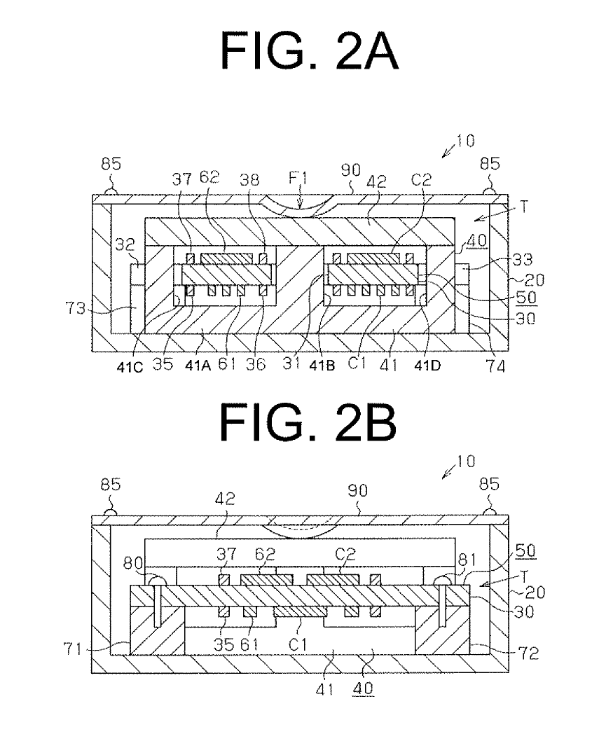

The following will describe the induction device according to the embodiment of the present invention with reference to the accompanying drawings. Referring firstly to FIGS. 1A, 1B, 2A and 2B, the induction device is designated generally by reference numeral 10 and includes a metal case 20, an insulating substrate 30, a primary coil C1, a secondary coil C2, a magnetic core 40 and a bracket 90 serving as a pressing member. A transformer T that serves as an induction element includes the insulating substrate 30, the primary coil C1, the secondary coil C2 and the core 40. The primary coil C1 and the secondary coil C2 serve as a first coil and a second coil, respectively. The case 20 is a box whose top is opened.

A heavy copper board 50 and the core 40 are located in the case 20. The heavy copper board 50 is used to form the primary coil CI and the secondary coil C2. More specifically, the heavy copper board 50 has a first copper plate 61 forming the primary coil C1 and a second copper plate 62 forming the secondary coil C2. The primary coil C1 and the secondary coil C2 are formed so as to be wound around the core 40.

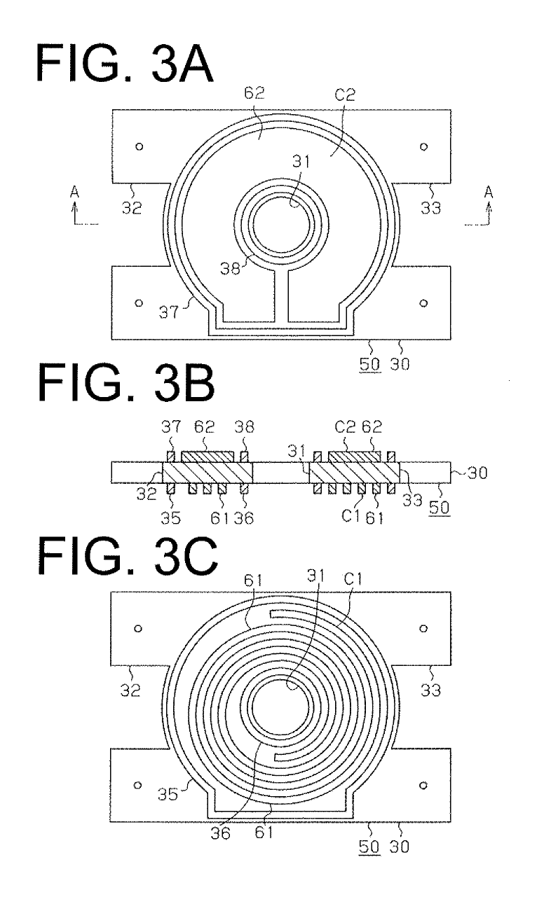

Referring to FIGS. 3A, 3B and 3C, the heavy copper board 50 includes the aforementioned insulating substrate 30, the first copper plate 61 and the second copper plate 62. The first copper plate 61 is bonded to the lower surface (or the first surface) of the insulating substrate 30. The primary coil C1 is provided by patterning of the first copper plate 61. The insulating substrate 30 is made of, for example, glass-reinforced epoxy.

The second copper plate 62 is bonded to the upper surface (or the second surface) of the insulating substrate 30. The secondary coil C2 is provided by patterning of the second copper plate 62. Thus, the primary coil C1 and the secondary coil C2 are held by the insulating substrate 30.

As shown in FIGS. 1A, 1B, 2A and 2B, the core 40 is of an El core having an E-shaped core 41 and an I-shaped core 42. The E-shaped core 41 includes a rectangular plate 41A that extends horizontally, a center leg 41B that projects from the center of the upper side of the plate 41A, outer legs 41C and 41D that project from the ends of the upper side of the plate 41A. The center leg 41B is of a cylindrical column and the outer legs 41C and 41D are of a rectangular column.

The I-shaped core 42 includes a rectangular plate that extends horizontally. The distal end faces of the center leg 41B and the outer legs 41B and 41C of the E-shaped core 41 are placed in abutting contact with the lower surface of the I-shaped core 42 thereby to form the E-I core having a closed magnetic circuit.

The insulating substrate 30 of the heavy copper board 50 has at the center thereof a round hole 31 through which the center leg 41B of the E-shaped core 41 extends, as shown in FIGS. 3A-3C. The primary coil C1 provided by patterning of the first copper plate 61 of the heavy copper board 50 is formed in a spiral shape of a conductor centered on the hole 31 of the insulating substrate 30 and forms plural turns of the conductor around the center leg 41B of the E-shaped core 41. Similarly, the secondary coil C2 provided by patterning of the second copper plate 62 of the heavy copper board 50 is formed in a spiral shape of a conductor centered on the hole 31 of the insulating substrate 30 and forms a single turn of the conductor around the center leg 41B of the E-shaped core 41. The center leg 41B of the E-shaped core 41 serves as a part of the core 40 around which the primary coil C1 and the secondary coil C2 are wound.

The insulating substrate 30 of the heavy copper board 50 has recesses 32 and 33 through which the outer legs 41C and 41D of the E-shaped core 41 extend, respectively, as shown in FIGS. 1A, 2A, 3A through 3C.

The hole 31 and the recesses 32, 33 of the insulating substrate 30 of the heavy copper board 50 are formed so as to allow the legs (or the center leg 41B and the outer legs 41C, 41D) of the E-shaped core 41 to pass therethrough. An annular insulating projection 35 is formed on the lower surface of the insulating substrate 30 between the outer periphery of the primary coil C1 and the outer peripheral surface of the insulating substrate 30, as shown in FIG. 3C. Similarly, an annular insulating projection 36 is formed on the lower surface of the insulating substrate 30 between the inner periphery of the primary coil C1 and the hole 31 of the insulating substrate 30, as shown in FIG. 3C.

An annular insulating projection 37 is formed on the upper surface of the insulating substrate 30 between the outer periphery of the secondary coil C2 and the outer peripheral surface of the insulating substrate 30, as shown in FIG. 3A. Similarly, an annular insulating projection 38 is formed on the upper surface of the insulating substrate 30 between the inner periphery of the secondary coil C2 and the hole 31 of the insulating substrate 30, as shown in FIG. 3A.

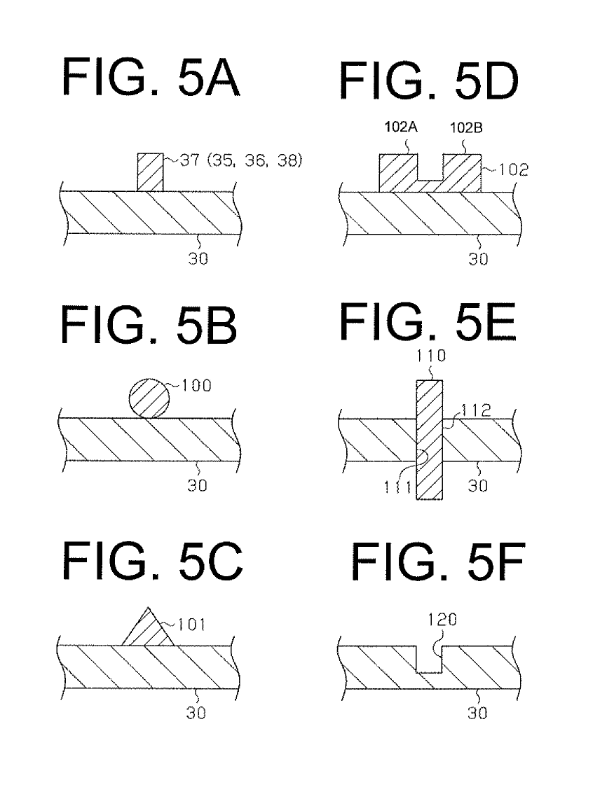

The insulating projections 35-38 are made of, for example, glass-reinforced epoxy. The insulating projections 35-38 are rectangular in cross section, as shown in FIG. 5A, and endlessly annular, as shown in FIGS. 3A and 3C.

The insulating projections 35-38 are bonded to the insulating substrate 30. More specifically, the insulating projections 35 and 36 have the same height as the primary coil C1 and the insulating projections 35, 36 and the primary coil C1 are press-bonded simultaneously to the lower surface of the insulating substrate 30. Similarly, the insulating projections 37 and 38 have the same height as the secondary coil C2 and the insulating projections 37, 38 and the secondary coil C2 are press-bonded simultaneously to the upper surface of the insulating substrate 30.

In manufacturing of the induction device 10, the insulating projections 35, 36 and the primary coil C1 are placed in indirect contact with the lower surface of the insulating substrate 30 via bond and the insulating projections 37, 38 and the secondary coil C2 are placed in indirect contact with the upper surface of the insulating substrate 30 via bond. Then, the insulating substrate 30 is placed on a base. A pressing member is lowered from upward for bonding the insulating projections 35-38 and the coils C1, C2 to the insulating substrate 30. In this case, the press-bonding is performed easily if the insulating projections 35 and 37 are located directly across the insulating substrate 30 and the insulating projections 36 and 38 are also located directly across the insulating substrate 30,.

As shown in FIGS. 1A-2B, the case 20 is in the form of box whose top is opened and made of aluminum. The E-shaped core 41 is placed on the inner surface of the bottom of the case 20. More specifically, the rectangular plate 41A of the E-shaped core 41 is set in contact with the inner surface of the bottom of the case 20, and the center leg 41B and the outer legs 41C, 41D extend upward from the rectangular plate 41A.

The case 20 is grounded. The case 20 has fixing parts 71, 72, 73, 74 at positions that are adjacent to the four corners of the case 20 and radially outward of the center leg 41B of the E-shaped core 41. The fixing parts 71-74 are cylindrical and fixed to the inner surface of the bottom of the case 20 at positions adjacent to the respective corners of the insulating substrate 30, as shown in FIG. 1A.

The heavy copper board 50 is placed on the fixing parts 71-74 and fixed by screws 80, 81, 82, 83 extending through the insulating substrate 30 of the heavy copper board 50 and screwed into the fixing parts 71-74.

Thus, the insulating substrate 30 of the heavy copper board 50 is fixed to the case 20. That is, the insulating substrate 30 located in the case 20 is fixed to the fixing parts 71-74 of the case 20 by the screws 80-83, respectively. The coils C1 and C2 are formed on the lower surface and the upper surface of the insulating substrate 30, respectively.

In the above-described structure, the heavy copper board 50 is located above the rectangular plate 41A of the E-shaped core 41 and the center leg 41B of the E-shaped core 41 extends through the hole 31 of the insulating substrate 30 of the heavy copper board 50. The primary coil C1 provided by patterning of the first copper plate 61 is spaced away from the upper surface of the rectangular plate 41A of the E-shaped core 41 by air gap. The secondary coil C2 provided by patterning of the second copper plate 62 is spaced away from the lower surface of the I-shaped core 42 by air gap.

As shown in FIGS. 1B, 2A and 2B, the bracket 90 that serves also as a cover is mounted on the case 20 by screws 85 so as to cover the opening of the case 20. Elastic force F1 of the bracket 90 urges the I-shaped core 42 downward thereby to press the I-shaped core 42 against the E-shaped core 41. That is, the core 40 is pressed from above and below, and fixed on the case 20.

Thus, the core 40 located in the case 20 is fixed to the case 20 by the pressing force of the bracket 90. It is noted that the bracket 90 and the I-shaped core 42 shown in FIGS. 1B, 2A and 2B is omitted from illustration in FIG. 1A.

As shown in FIGS. 1B and 2A, the insulating projection 36 is formed on the lower surface of the insulating substrate 30 between the coil C1 and the center leg 41B of the E-shaped core 41, and the insulating projection 38 is formed on the upper surface of the insulating substrate 30 between the coil C2 and the center leg 41B of the E-shaped core 41. In addition, the insulating projection 35 is formed on the lower surface of the insulating substrate 30 between the coil C1 and the outer legs 41C, 41D of the E-shaped core 41, and the insulating projection 37 is formed on the upper surface of the insulating substrate 30 between the coil C2 and the outer legs 41C, 41D of the E-shaped core 41. Further, the insulating projection 35 is formed on the lower surface of the insulating substrate 30 between the coil C1 and the case 20, and the insulating projection 37 is formed on the upper surface of the insulating substrate 30 between the coil C2 and the case 20. The insulating projections 35-38 are located between the coils C1, C2 and the core 40.

The following will describe the operation of the induction device 10. In assembling the induction device 10, the case 20, the heavy copper board 50, the E-shaped core 41, the I-shaped core 42 and the bracket 90 are prepared. First of all, the E-shaped core 41 is placed on the inner surface of the bottom of the case 20.

Subsequently, the heavy copper board 50 is placed on the fixing parts 71-74 of the case 20 and fixed thereto by the screws 80-83, respectively. In this state, the center leg 41B and the outer legs 41C, 41D of the E-shaped core 41 extend through the hole 31 and the recesses 32, 33 of the heavy copper board 50, respectively.

Then, the I-shaped core 42 is placed on the E-shaped core 41. The bracket 90 is mounted on the case 20 by the screws 85 so as to cover the opening of the case 20. The elastic force F1 of the bracket 90 urges the I-shaped core 42 downward. Thus, the I-shaped core 42 is held firmly on the E-shaped core 41.

After the induction device 10 has been thus assembled, an electric current is passed through the primary coil C1 and the secondary coil C2 of the induction device 10. In accordance with the passage of the electric current, the primary coil C1 (or the first copper plate 61) and the secondary coil C2 (or the second copper plate 62) generate heat. The heat is released from the coils C1 and C2 to outside air. The heat of the core 40 is released from the E-shaped core 41 to the case 20.

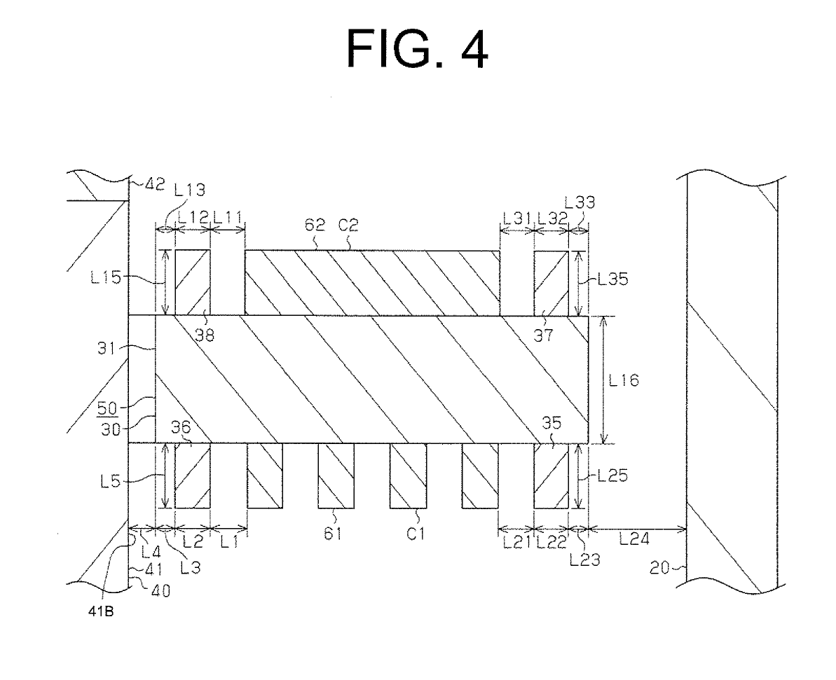

The following will describe, with reference to FIG. 4, how the creepage distance is ensured in the induction device 10. The creepage distance between the primary coil C1 and the center leg 41B of the E-shaped core 41 will be now calculated.

The horizontal distance between the primary coil C1 and the insulating projection 36 is represented by L1, the horizontal thickness of the insulating projection 36 is by L2, and the horizontal distance between the insulating projection 36 and the inner wall surface (or the hole 31) of the insulating substrate 30 is by L3. In addition, the horizontal distance between the inner wall surface of the insulating substrate 30 and the center leg 41B of the E-shaped core 41 is represented by L4, and the height of the insulating projection 36 is by L5. Therefore, the creepage distance between the primary coil C1 and the center leg 41B of the E-shaped core 41 is expressed by the following.

L1+L5+L2+L5+L3+L4

That is, if no insulating projection such as 36 is present on the insulating substrate 30, the creepage distance is L1+L2+L3+L4 that is less than the above creepage distance by twice the height (L5) of the insulating projection 36. In the present embodiment wherein the insulating projection 36 is formed on the insulating substrate 30, however, the creepage distance is ensured not only by the horizontal distance between the primary coil C1 and the center leg 41B of the E-shaped core 41, but also by the distance that is twice the height (L5) of the insulating projection 36 (or 2*L5), so that the horizontal distance between the primary coil C1 and the center leg 41B of the E-shaped core 41 may be shortened.

The creepage distance between the primary coil C1 and the secondary coil C2 through the hole 31 of the insulating substrate 30 will be now calculated. The horizontal distance between the secondary coil C2 and the insulating projection 38 is represented by L11, the horizontal thickness of the insulating projection 38 is by L12, and the horizontal distance between the insulating projection 38 and the inner wall surface (or the hole 31) of the insulating substrate 30 is by L13. In addition, the height of the insulating projection 38 is represented by L15, and the thickness of the insulating substrate 30 is by L16. Therefore, the creepage distance between the primary coil C1 and the secondary coil C2 is expressed by the following.

L1+L5+L2+L5+L3+L16+L13+L15+L12+L15+L11

That is, if no insulating projections such as 36 and 38 are present on the insulating substrate 30, the creepage distance is L1+L2+L3+L16+L13+L12+L11 that is less than the above creepage distance by twice the height (L5) of the insulating projection 36 and twice the height (L15) of the insulating projection 38. In the present embodiment wherein the insulating projections 36 and 38 are formed on the insulating substrate 30, however, the creepage distance is ensured not only by the distance between the primary coil C1 and the secondary coil C2 through the hole 31 of the insulating substrate 30, but also by the distance that is twice the height (L5, L15) of the insulating projections 36 and 38 (or 2*L5+2*L15), so that the distance between the primary coil C1 and the secondary coil C2 through the hole 31 of the insulating substrate 30 may be shortened.

The creepage distance between the primary coil C1 and the case 20 will be now calculated. The horizontal distance between the primary coil C1 and the insulating projection 35 is represented by L21, the horizontal thickness of the insulating projection 35 is by L22, and the horizontal distance between the insulating projection 35 and the outer peripheral surface of the insulating substrate 30 is by L23. In addition, the horizontal distance between the outer peripheral surface of the insulating substrate 30 and the case 20 is represented by L24, and the height of the insulating projection 35 is by L25. Therefore, the creepage distance between the primary coil C1 and the case 20 is expressed by the following.

L21+L25+L22+L25+L23+L24

That is, if no insulating projection such as 35 is present on the insulating substrate 30, the creepage distance is L21+L22+L23+L24 that is less than the above creepage distance by twice the height (L25) of the insulating projection 35. In the present embodiment wherein the insulating projection 35 is formed on the insulating substrate 30, however, the creepage distance is ensured not only by the horizontal distance between the primary coil C1 and the case 20, but also by the distance that is twice the height (L25) of the insulating projection 35 (or 2*L25), so that the horizontal distance between the primary coil C1 and the case 20 may be shortened.

The creepage distance between the primary coil C1 and the secondary coil C2 through the outer peripheral surface of the insulating substrate 30 will be now calculated. The horizontal distance between the secondary coil C2 and the insulating projection 37 is represented by L31, the horizontal thickness of the insulating projection 37 is by L32, and the horizontal distance between the insulating projection 37 and the outer peripheral surface of the insulating substrate 30 is by L33. In addition, the height of the insulating projection 37 is represented by L35. Therefore, the creepage distance between the primary coil C1 and the secondary coil C2 is expressed by the following.

L21+L25+L22+L25+L23+L16+L33+L35+L32+L35+L31

That is, if no insulating projections such as 35 and 37 are present on the insulating substrate 30, the creepage distance is L21 +L22 +L23 +L16 +L33 +L32 +L31 that is less than the above creepage distance by twice the height (L25) of the insulating projection 35 and twice the height (L35) of the insulating projection 37. In the present embodiment wherein the insulating projections 35 and 37 are formed on the insulating substrate 30, however, the creepage distance is ensured not only by the distance between the primary coil C1 and the secondary coil C2 through the outer peripheral surface of the insulating substrate 30, but also by the distance that is twice the height (L25, L35) of the insulating projections 35 and 37 (or 2*L25+2*L35), so that the distance between the primary coil C1 and the secondary coil C2 through the outer peripheral surface of the insulating substrate 30 may be shortened.

The same is true for the creepage distance between the secondary coil C2 and the center leg 41B of the E-shaped core 41 because the insulating projection 38 is formed between the secondary coil C2 and the center leg 41B of the E-shaped core 41. The same is also true for the creepage distance between the secondary coil C2 and the case 20 because the insulating projection 37 is formed between the secondary coil C2 and the case 20. The same is also true for the creepage distances between the primary coil C1 and the outer legs 41C, 41D of the E-shaped core 41 because the insulating projection 35 is formed between the primary coil C1 and the outer legs 41C, 41D of the E-shaped core 41. The same is also true for the creepage distances between the secondary coil C2 and the outer legs 41C, 41D of the E-shaped core 41 because the insulating projection 37 is formed between the secondary coil C2 and the outer legs 41C, 41D of the E-shaped core 41.

If no insulating projections 35-38 are present in the induction device 10, it is difficult to maintain the distances between the core 40 and the coils C1, C2 which are fixed in the induction device 10 independently with respect to the case 20. However, the provision of the insulating projections 35-38 helps to ensure the creepage distance. More specifically, although the insulating substrate 30, which is fixed by the screws 80-83 in the case 20, is difficult to be set in the case 20 in its accurate horizontal position, the provision of the insulating projections 35-38 helps to ensure the creepage distance. That is, the creepage distance is ensured by the insulating projections 35-38 without increasing the size of the insulating substrate 30.

The above-described embodiment of the present invention has the following advantageous effects.

(1) The transformer T that serves as an induction element includes the insulating substrate 30, the primary coil C1, the secondary coil C2, the core 40 and the insulating projections 35-38. The insulating projections 35 and 36 are formed on the lower surface of the insulating substrate 30 between the primary coil C1 and the core 40, and the insulating projections 37 and 38 are formed on the upper surface of the insulating substrate 30 between the secondary coil C2 and the core 40. Therefore, the creepage distances between the core 40 and the respective coils C1, C2 are increased by the insulating projections 35-38 without increasing the projection area (or size) of the insulating substrate 30. Thus, the creepage distances of the transformer T are ensured without increasing the size of the insulating substrate 30.

That is, the creepage distances of the transformer T are ensured without increasing the distance (in planar direction) between the patterns of each of the copper plates 61, 62. Thus, the size of the heavy copper board 50 may be reduced and, therefore, the size of parts such as a transformer is reduced.

(2) In the present embodiment, the creepage distances between the core 40 and the respective coils C1, C2 are ensured by providing the insulating projections 35 and 36 formed on the lower surface of the insulating substrate 30 between the primary coil C1 and the core 40 and the insulating projections 37 and 38 formed on the upper surface of the insulating substrate 30 between the secondary coil C2 and the core 40.

In the field of a switching supply that produces significant power, a heavy copper board has been developed. In the heavy copper board, copper patterns are fixed on a substrate so as to allow a high current to flow. Thus, an inexpensive board has been materialized. The heavy copper board makes possible connection of a circuit component and formation of a coil of a is transformer. In designing an induction device using such a heavy copper board, creepage distance between the copper patterns of the heavy copper board needs to be ensured for successful insulation. Although the creepage distance may be ensured generally by providing a distance between the copper patterns that is large enough for the insulation, the provision of the distance causes the size of the heavy copper board to be increased. In the present embodiment wherein the transformer T includes the heavy copper board having the insulating projections, however, the creepage distance of the transformer T may be ensured without increasing the size of the heavy copper board, which makes it possible to reduce the size of the heavy copper board.

(3) In the induction device 10, the insulating projections 35 and 37 which are formed on the lower and upper surface of the insulating substrate 30 between the case 20 and the respective coils C1, C2 ensure the creepage distances between the case 20 and the respective coils C1, C2 without increasing the size of the insulating substrate 30.

The present invention has been described in the context of the above-described embodiment, but it is not limited to the embodiment. It is obvious to those skilled in the art that the invention may be practiced in various manners as exemplified below.

Although the insulating projection 37 (35, 36, 38) is rectangular in cross-section as shown in FIG. 5A, an insulating projection 100 that is circular in cross-section as shown in FIG. 5B may be used.

As shown in FIG. 5C, an insulating projection 101 that is triangular in cross-section may be used.

The insulating projection according to the present invention may be of any desired shape including, but not limited to, trapezoidal or star-shape in cross-section.

As shown in FIG. 5D, an insulating projection 102 having a double projection may be used. In this case, the two projections 102A and 102B are formed integrally thereby to make the insulating projection 102. An insulating projection having any other multiple projections may be used.

As shown in FIG. 5E, an insulating projection 110 may be formed by fitting an insulating member 112 through a hole 111 that extends through the insulating substrate 30. Alternatively, an insulating projection may be formed by inserting an insulating member through a hole that extends through the insulating substrate 30 and fixing the insulating member to the insulating substrate 30 by using resin.

Instead of forming the insulating projection 37 (35, 36, 38) on the insulating substrate 30, a groove 120 may be formed in the insulating substrate 30 as shown in FIG. 5F.

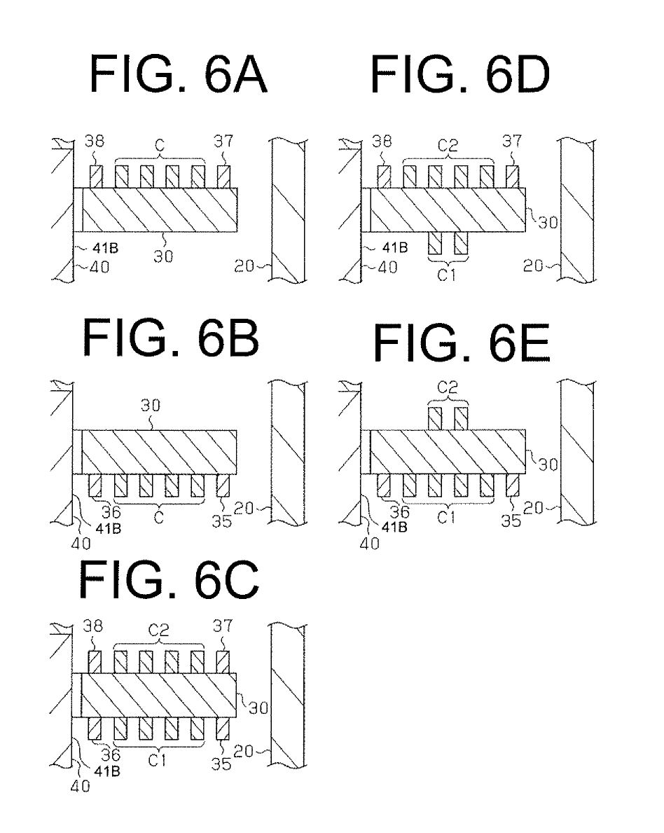

Although in the above-described embodiment and variations the coils C1 and C2 are formed on both surfaces of the insulating substrate 30, the coil C may be formed only on one surface of the insulating substrate 30, as shown in FIGS. 6A and 6B, Referring to FIG. 6A, the insulating projections 38 (or a groove) and 37 (or a groove) are formed on (or in) the surface of the insulating substrate 30 on which the coil C is formed, between the coil C and the core 40 and between the coil C and the case 20, respectively. Alternatively, only the insulating projection 38 (or a groove) may be formed on (or in) the surface of the insulating substrate 30 on which the coil C is formed, between the coil C and the core 40. Alternatively, only the insulating projection 37 (or a groove) may be formed on (or in) the surface of the insulating substrate 30 on which the coil C is formed, between the coil C and the case 20. Referring to FIG. 6B, the insulating projections 36 (or a groove) and 35 (or a groove) are formed on (or in) the surface of the insulating substrate 30 on which the coil C is formed, between the coil C and the core 40 and between the coil C and the case 20, respectively. Alternatively, only the insulating projection 36 (or a groove) may be formed on (or in) the surface of the insulating substrate 30 on which the coil C is formed, between the coil C and the core 40. Alternatively, only the insulating projection 35 (or a groove) may be formed on (or in) the surface of the insulating substrate 30 on which the coil C is formed, between the coil C and the case 20. The provision of the insulating projections 35-38 (or the grooves) ensures the creepage distances between the coils C1, C2 and the core 40 or the case 20 without increasing the size of the insulating substrate 30.

As shown in FIG. 6C, in the induction element wherein the coils C1 and C2 are formed on the respective surfaces of the insulating substrate 30, the insulating projections 38 (or a groove) and 37 (or a groove) are formed on (or in) the surface of the insulating substrate 30 on which the coil C2 is formed, between the coil C2 and the core 40 and between the coil C2 and the case 20, respectively, and the insulating projections 36 (or a groove) and 35 (or a groove) are formed on (or in) the surface of the insulating substrate 30 on which the coil C1 is formed, between the coil C1 and the core 40 and between the coil C1 and the case 20, respectively. Alternatively, in the induction element wherein the coils C1 and C2 are formed on the respective surfaces of the insulating substrate 30, when the insulating projections 38 (or a groove) and 37 (or a groove) are formed on (or in) the surface of the insulating substrate 30 on which the coil C2 is formed, between the coil C2 and the core 40 and between the coil C2 and the case 20, respectively, only the insulating projection 36 or 35 (or a groove) may be formed on (or in) the surface of the insulating substrate 30 on which the coil C1 is formed, between the coil C1 and the core 40 or between the coil C1 and the case 20, respectively. Alternatively, in the induction element wherein the coils C1 and C2 are formed on the respective surfaces of the insulating substrate 30, when the insulating projections 36 (or a groove) and 35 (or a groove) are formed on (or in) the surface of the insulating substrate 30 on which the coil C1 is formed, between the coil C1 and the core 40 and between the coil C1 and the case 20, respectively, only the insulating projection 38 or 37 (or a groove) may be formed on (or in) the surface of the insulating substrate 30 on which the coil C2 is formed, between the coil C2 and the core 40 or between the coil C2 and the case 20, respectively. Alternatively, in the induction element wherein the coils C1 and C2 are formed on the respective surfaces of the insulating substrate 30, when only the insulating projection 38 or 37 (or a groove) is formed on (or in) the surface of the insulating substrate 30 on which the coil C2 is formed, between the coil C2 and the core 40 or between the coil C2 and the case 20, respectively, only the insulating projection 36 or 35 (or a groove) may be formed on (or in) the surface of the insulating substrate 30 on which the coil C1 is formed, between the coil C1 and the core 40 or between the coil C1 and the case 20, respectively. The provision of the insulating projections 35-38 (or the grooves) ensures the creepage distances between the coils C1, C2 and the core 40 or the case 20 without increasing the size of the insulating substrate 30.

As shown in FIG. 6D, in the induction element wherein the coils C1 and C2 are formed on the respective surfaces of the insulating substrate 30, the insulating projections 38 (or a groove) and 37 (or a groove) are formed on (or in) the surface of the insulating substrate 30 on which the coil C2 is formed, between the coil C2 and the core 40 and between the coil C2 and the case 20, respectively. Alternatively, in the induction element wherein the coils C1 and C2 are formed on the respective surfaces of the insulating substrate 30, only the insulating projection 38 (or a groove) may be formed on (or in) the surface of the insulating substrate 30 on which the coil C2 is formed, between the coil C2 and the core 40. Alternatively, in the induction element wherein the coils C1 and C2 are formed on the respective surfaces of the insulating substrate 30, only the insulating projection 37 (or a groove) may be formed on (or in) the surface of the insulating substrate 30 on which the coil C2 is formed, between the coil C and the case 20. As shown in FIG. 6E, in the induction element wherein the coils C1 and C2 are formed on the respective surfaces of the insulating substrate 30, the insulating projections 36 (or a groove) and 35 (or a groove) are formed on (or in) the surface of the insulating substrate 30 on which the coil C1 is formed, between the coil C2 and the core 40 and between the coil C2 and the case 20, respectively. Alternatively, in the induction element wherein the coils C1 and C2 are formed on the respective surfaces of the insulating substrate 30, only the insulating projection 36 (or a groove) may be formed on (or in) the surface of the insulating substrate 30 on which the coil C1 is formed, between the coil C1 and the core 40. Alternatively, in the induction element wherein the coils C1 and C2 are formed on the respective surfaces of the insulating substrate 30, only the insulating projection 35 (or a groove) may be formed on (or in) the surface of the insulating substrate 30 on which the coil C1 is formed, between the coil C1 and the case 20. The provision of the insulating projections 35-38 (or the grooves) ensures the creepage distances between the coils C1, C2 and the core 40 or the case 20 without increasing the size of the insulating substrate 30.

The copper plate bonded to the insulating substrate of the heavy cooper board 50 in the above-described embodiment may be replaced by an aluminum plate. The heavy cooper board may be substituted by a printed circuit board.

Although the induction device 10 of the above-described embodiment has a transformer, it may be configured to have a reactor instead of the transformer. More specifically, a first coil and a second coil are located on the opposite surfaces of the insulating substrate and electrically connected to each other thereby to form the reactor.

The insulating projections 35-38, which are made of glass-reinforced epoxy in the embodiment, may be made of resin and/or rubber.

What is claimed is:

1. An induction element comprising:
an insulating substrate;
a coil formed on at least a surface of the insulating substrate;
a core having a part around which the coil is wound; and
an insulating projection or a groove formed on or in the surface of the insulating substrate between the coil and the core.

2. The induction element according to claim 1, wherein the insulating projection is circular in cross-section.

3. The induction element according to claim 1, wherein the insulating projection is triangular in cross-section.

4. The induction element according to claim 1, wherein the insulating projection has a double projection.

5. The induction element according to claim 1, wherein the insulating projection is formed by fitting an insulating member through a hole that extends through the insulating substrate.

6. An induction device comprising:
a case;
an insulating substrate fixed in the case;
a coil formed on at least a surface of the insulating substrate;
a core located in the case and having a part around which the coil is wound;
a pressing member for fixing the core to the case; and
an insulating projection or a groove formed on or in the surface of the insulating substrate between the coil and the case.
